(19) United States
(12) Patent Application Publication
(10) Pub. No.: US 2025/0155403 A1
(43) Pub. Date: May 15, 2025

(54) SYSTEMS AND PROCESS FOR CALIBRATING A SENSOR USED IN A SULFUR EXTRACTION PROCESS

(71) Applicant: UOP LLC, Des Plaines, IL (US)

(72) Inventors: Jatin Kumar, Haryana (IN); Jessy E. Trucko, Lake Forest, IL (US); Howard J. Greenberg, Woodridge, IL (US); George E. Mickelson, Sturtevant, WI (US)

(21) Appl. No.: 18/778,202

(22) Filed: Jul. 19, 2024

Related U.S. Application Data
(60) Provisional application No. 63/599,073, filed on Nov. 15, 2023.

(51) Int. Cl. G01N 27/416; B01D 53/14

(52) U.S. Cl. CPC G01N 27/4163; B01D 53/1468; G01N 27/4168; B01D 2257/30

(57) ABSTRACT

Systems and processes for removing sulfur compounds from a hydrocarbon stream. Sulfur compounds are extracted from a hydrocarbon feed stream with a caustic stream to provide a treated hydrocarbon stream and a rich caustic stream. The sulfur compounds in the rich caustic stream are oxidized in the presence of a catalyst to provide a lean caustic stream. The lean caustic stream is returned to extract sulfur from the hydrocarbon stream. Data such as a concentration of sulfurs species and degree of caustic saturation with the sulfur species in the rich caustic stream may be provided by a sensor, compared against other real-time or historical data and used to provide a recommended adjustment to process conditions associated with an extraction unit, or an oxidation unit, or both.

### CROSS-REFERENCES TO RELATED APPLICATIONS

This application claims the benefit of U.S. Patent Applicant Ser. No. 63/599,073 filed on Nov. 15, 2023, the entire disclosure of which is incorporated herein by way of reference.

### FIELD OF THE INVENTION

This invention relates generally to processes for removing sulfur from hydrocarbons, and more particularly to calibrating a sensor used in a sulfur removal process.

### BACKGROUND OF THE INVENTION

Petroleum refining and petrochemical processes frequently involve treating processes which remove sulfur compounds from hydrocarbon streams. In these processes, mercaptans or hydrogen sulfide present in gas or liquid hydrocarbon streams such as natural gas, naphtha, or liquid petroleum gas are extracted into an aqueous alkaline solution to form a caustic stream rich in mercaptide or sulfide species. The extracted hydrogen sulfide may be oxidized to form the analogous thiosulfate or sulfate salt. The extracted mercaptans in the rich caustic stream may be oxidized to form disulfide compounds. The disulfides separate from the caustic, providing a lean caustic stream that is recycled to extract sulfur from the hydrocarbon stream.

The concentration of mercaptides in caustic is an important piece of data to monitor the operations of the unit, determine if adjustments need to be made, or to prevent upsets. Current processes obtain information associated with the lean caustic stream. Some current analytical method uses off-line laboratory analysis to measure the value. This analysis, however, is difficult to run and it may be done too infrequently. There is also a manual test that can be done at the unit, but the results are very qualitative. Further, it has been proposed to use an electrode system, which has limitations and only applies to mercaptides.

More recently, online sensors, such as an ORP sensor, have been suggested for utilization in sulfur extractions processes to obtain data. While presumably effective for their intended purposes, such sensors may require initial and/or continuous calibration in order to ensure that accurate data is obtained and relied on for the sulfur extraction process.

Therefore, there remains a need for an effective and efficient process for obtaining accurate information regarding the caustic stream in a sulfur extraction process.

### SUMMARY OF THE INVENTION

One or more processes for calibrating a sensor used in a sulfur extraction process have been invented. The processes, generally, use calibration data to compare against data obtained from a sensor. When the obtained data differs from the calibration data, new calibration data may be obtained and used to calibrate the sensor.

The present invention may, therefore, be characterized, in at least one aspect, as providing a method for validating a sensor used in a process for extracting sulfur compounds from a hydrocarbon stream by: obtaining a sensor data regarding a stream from a sulfur extraction process; determining a sulfur concentration data from the sensor data; and, comparing the sulfur concentration data to a first calibration data to determine a difference between the between the sulfur concentration data and the first calibration data.

The first calibration data may be data from an offline line analysis.

When a difference between the sulfur concentration data and the first calibration data is above a threshold, the method may also include developing a second calibration data. The second calibration data may be data from an offline line analysis. The method may also include comparing the sulfur concentration data to the second calibration data to determine a second difference between the between the sulfur concentration data and the second calibration data. When the second difference is above a second threshold, the process may include calibrating the sensor based on the second calibration data.

The process may include determining a sulfur concentration data from the sensor data based in part on a temperature measurement.

The sensor may be an ORP sensor.

The stream from a sulfur extraction process comprises may be a caustic stream.

Comparing the sulfur concentration data to a first calibration data to determine a difference between the between the sulfur concentration data and the first calibration data may be performed at regular intervals.

The present invention may also be generally characterized in at least one aspect as providing a method for calibrating a sensor used in a process for extracting sulfur compounds from a hydrocarbon stream by: obtaining a sensor data regarding a stream from a sulfur extraction process; determining a sulfur concentration data from the sensor data; comparing the sulfur concentration data to a first calibration data to determine a difference between the between the sulfur concentration data and the first calibration data; and, when a difference between the sulfur concentration data and the first calibration data is above a threshold, comparing the sulfur concentration data to a second calibration data different from the first calibration data to calibrate the sensor.

Again, the sensor may be an ORP sensor.

The stream from a sulfur extraction process may be a caustic stream.

Determining a sulfur concentration data from the sensor data may utilize a temperature measurement.

The first calibration data may be data from an offline line analysis, or the second calibration data may be data from an offline line analysis, or both may be from an offline analysis.

Comparing the sulfur concentration data to a calibration data may be performed at regular intervals.

In some aspects the present invention may be characterized, broadly has providing a process for removing sulfur compounds from a hydrocarbon stream by: extracting sulfur compounds with a caustic stream from a hydrocarbon feed stream to provide a treated hydrocarbon stream and a rich caustic stream; obtaining, with an ORP sensor, an ORP data regarding the rich caustic stream; oxidizing the sulfur compounds in the rich caustic stream in a presence of a catalyst to provide a lean caustic stream; determining a sulfur concentration data from the ORP data; comparing the sulfur concentration data to a first calibration data to determine a difference between the between the sulfur concentration data and the first calibration data; and, when a difference between the sulfur concentration data and the first calibration data is below a threshold, recommending at least one change to an operating condition associated with the process for removing sulfur compounds from the hydrocarbon stream.

Determining a sulfur concentration data from the sensor data may utilize, in part, a temperature measurement.

When a difference between the sulfur concentration data and the first calibration data is above a threshold, the process may also include comparing the sulfur concentration data to a second calibration data different from the first calibration data to calibrate the sensor. The process may include developing the second calibration data. The second calibration data may be developed in an offline test.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

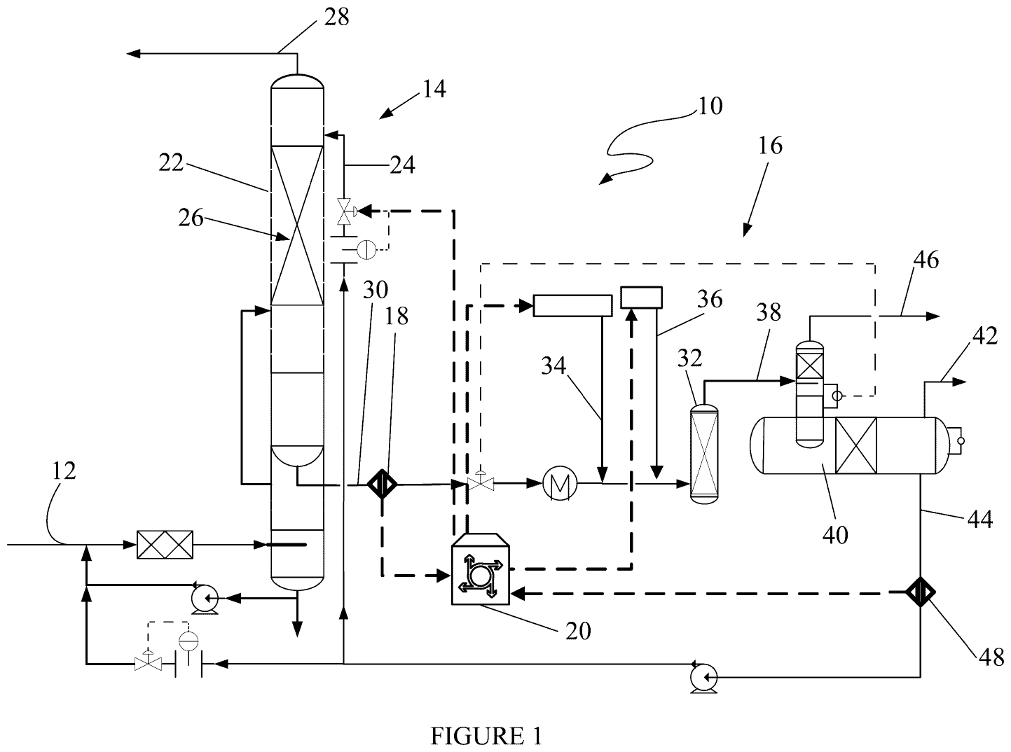

FIG. 1 shows a schematic process flow diagram of a system used for a sulfur removal from a hydrocarbon stream; and,

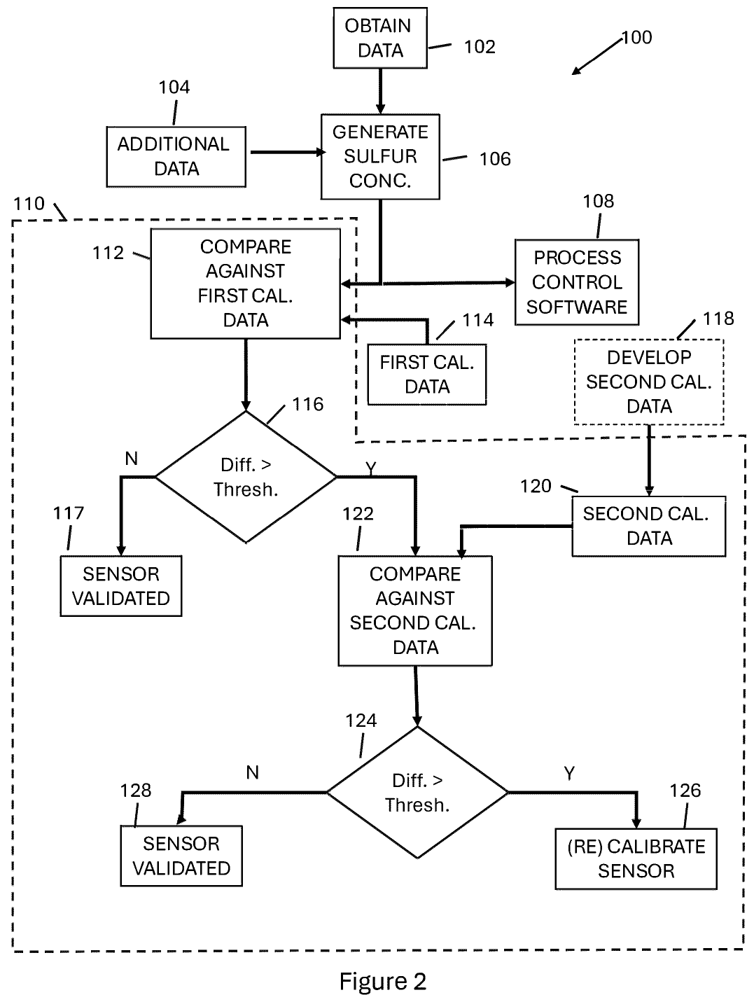

FIG. 2 shows a process flow diagram for calibrating a sensor.

### DETAILED DESCRIPTION OF THE INVENTION

As mentioned above, the present invention provides processes for validating and calibrating a sensor associated with a stream of an sulfur extraction process. By validating and calibrating the sensor, the present inventions better ensures that the data obtain is accurate and thus more reliable.

With these general principles in mind, one or more embodiments of the present invention will be described with the understanding that the following description is not intended to be limiting.

As shown in FIG. 1, a system 10 for removing sulfur compounds from a hydrocarbon stream 12 includes an extraction unit 14, an oxidation unit 16, a sensor 18, and a controller 20 in communication with the sensor 18.

The extraction unit 14 comprises a vessel 22 that receives the hydrocarbon stream 12 to be treated to remove sulfur compounds contained in the hydrocarbon stream 12. Example sources of the hydrocarbon stream 12 include natural gas fractionation facilities, a crude fractionation tower, a coker, an FCC unit, and the like. The vessel 22 of the extraction unit 14 also receives a caustic stream 24.

In an extraction section 26 of the vessel 22, the caustic flows counter current (downward as shown in FIG. 1) to the direction of flow of the hydrocarbons (upward as shown in FIG. 1). As a result of the contact between the two, sulfur compounds are extracted from the hydrocarbons into the caustic. The extraction may also be achieved with other contacting devices, mixer settlers, or a thin film extraction to name a few.

A treated hydrocarbon stream 28 may be recovered from the extraction section 26 of the vessel 22. Compared with the hydrocarbon stream 12, the treated hydrocarbon stream 28 has a lower amount of sulfur compounds.

A rich caustic stream 30 is also recovered from the extraction section 26 of the vessel 22. Compared with the caustic stream 24, the rich caustic stream 30 has a higher amount of sulfur compounds. Generally, the rich caustic stream 30 has more than 120 wppm sodium mercaptide as sulfur, and it may contain other sulfur compounds like sodium sulfide or sodium bisulfide. To remove the sulfur compounds from the rich caustic stream 30, the rich caustic stream 30 is passed to the oxidation unit 16.

The oxidation unit 16 includes at least one vessel 32 that receives the rich caustic stream 30. The vessel 32 also receives a stream of catalyst 34 and a stream of oxidant 36 which may be an oxygen containing gas or a liquid oxidant, like hydrogen peroxide, or a combination thereof. As depicted, these additional streams 34, 36 are combined with the rich caustic stream 30 and passed as a single stream into the vessel 32. Within the vessel 32, the captured sulfur compounds are oxidized by oxygen, in the presence of the catalyst, and form disulfides.

An oxidized caustic stream 38 from the vessel 32 may be passed to a second vessel 40 which allows for separation of the oxidized caustic stream 38 into three phases, including a gaseous phase and two liquid phases. A first liquid phase 42 comprises the disulfides which may be removed and processed as is known. The second liquid phase comprises the caustic which may be recovered from the second vessel 40 as a lean caustic stream 44. The lean caustic stream 44 may have less than 120 wppm sodium mercaptide as sulfur. The gaseous phase, a spent air stream 46, may also be recovered from the second vessel 40. A degassing section may be utilized in the vessel 32 as disclosed in U.S. Pat. Pub. No. 2014/0235897.

To obtain an online measurement that could be used to determine a sulfur concentration, a sensor 18 is provided in a line with the rich caustic stream 30. The sensor 18 may be an electrochemical potential meter, like an ORP sensor, or any other sensor that may be used to measure a characteristic indicative of a mercaptide concentration. The electrochemical potential meter sensor may be utilized as the sensor 18 to obtain information concerning the degree of saturation of the sulfur species in the rich caustic stream 30 based on an electrochemical potential of the stream 30. This could indicate if there is hydrogen sulfide entering the extraction unit 14.

Signals, measurements, and/or data generated or recorded by the sensor 18 are transmitted to the controller 20, which may be local to the system 10 or it may be remotely located. The controller 20 is a computing devices or systems that includes at least one processor and memory storing computer-readable instructions that, when executed by the at least one processor, cause the one or more computing devices to perform a process that may include one or more steps. The controller 20 or a computing device may be, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The controller 20 may be configured to receive, from the sensor 18, data and may be configured to analyze the data. Based on analyzing the data, the controller 20 may be configured to determine one or more recommended adjustments to one or more parameters of one or more processes described herein. The controller 20 may be configured to transmit encrypted or unencrypted data that includes the one or more recommended adjustments to the one or more parameters of the one or more processes described herein.

More specifically, the controller 20 may compare the obtained data from the sensor 18 against a second data. The second data may include real time data, stored data, or a combination thereof. For example, a database of past data may be maintained in memory associated with the controller 20.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by the controller or a computing device.

The past data may be from the sensor 18, or it may be from another source of data. For example, the second data may be obtained via a second sensor 48 which is configured to obtain data regarding the lean caustic stream 44. The second sensor 48 may be the same type or kind as the first sensor 18. For example, both the first and the second sensor 18, 48 may be electrochemical potential meters or sensors. However, it is also contemplated that the sensor second 48 is a different kind or type from the first sensor 18.

Based, at least in part, on the comparison between the obtained data (from the first sensor 18) and the second data, the controller 20 is configured to recommend at least one change to an operating condition associated with the extraction unit 14, or the oxidation unit 16, or both. Other data may be utilized for the recommended change. Additionally, the controller 20 may be configured to send signals to one or more pieces of equipment such as a control valve, heater, timer, pump, or other similar device in order to implement the recommended change. The controller 20 may also send more than one recommendation-allowing one to be implemented or more than one to be implemented.

Possible changes or adjustments that may be recommended and/or implemented include: an adjustment of an amount of the caustic stream 24 mixed with the hydrocarbon feed stream 12; an adjustment of an amount of catalyst 34 added to the rich caustic stream 30; an adjustment to an amount of oxidant 36 mixed with the rich caustic stream 30; an adjustment to an amount of fresh caustic added to the process; an adjustment to an amount of water added to the process; an adjustment to an operating temperature of the oxidation unit 16; and combinations thereof.

As mentioned above, the data from the sensor 18 may, over time, fall out of alignment with the with original data. Accordingly, the present invention provides processes for validating and/or calibrating the sensor 18 to ensure that the data relied on is accurate.

Accordingly, as shown in FIG. 2, a process 100 begins with the sensor 18, 48 (FIG. 1) obtaining and providing a sensor data 102 regarding a stream from a sulfur extraction process. The stream may be the rich caustic stream 30 or the lean caustic stream 44. The data may be provided to controller 20. The controller 20 may also receive additional data 104, such as a temperature from a temperature sensor. The controller 20, from the obtained data, determines a sulfur concentration 106.

The sulfur concentration may be outputted and communicated to a process control software 108 which may display the sulfur concentration on various displays (real and virtual) and may use the sulfur concertation for to adjust process conditions as discussed above.

Additionally, a validation/calibration module 110, which may be a combination of hardware and instructions, or may be instructions within the controller 20 (See FIG. 1), may receive the sulfur concentration and compare the sulfur concentration 112 against a first calibration data 114. The first calibration data 114 may be an offline line lab analysis that provides sulfur concentration data that can be used to verify the accuracy of the determined sulfur concentration. The first calibration data 114 may be stored in the memory or may be inputted into the controller 20. The comparison 112 may be done iteratively at regular intervals, for example, every hour, every two hours, every day, etc.

When a difference 116 between the determined sulfur concentration data and the first calibration data is below a threshold, for example, +/−10%, or +/−5%, the sensor has been validated 117. When a difference 116 between the determined sulfur concentration data and the first calibration data is above the threshold, a second calibration data 120 may be developed 118. For example, a new laboratory analysis may be performed on a sample of the stream that is the source of the data.

The sulfur concentration data may then be compared 122 to the second calibration data 120 to determine a difference between the between the sulfur concentration data and the second calibration data. When a difference 124 between the sulfur concentration data and the second calibration data is above a second threshold, for example, +/−10%, or +/−5%, the sensor may be calibrated 126 to be based on the second calibration data. If the difference 124 between the sulfur concentration data and the second calibration data is below the second threshold, then the second calibration data has verified 128 the first calibration data and the sensor. The first and second threshold may the same or may be different.

With the foregoing processes, the sensor may be validated and/or calibrated to ensure that the data is accurate.

The methods and steps described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and processes described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

### SPECIFIC EMBODIMENTS

While the following is described in conjunction with specific embodiments, it will be understood that this description is intended to illustrate and not limit the scope of the preceding description and the appended claims.

A first embodiment of the invention is a method for validating a sensor used in a process for extracting sulfur compounds from a hydrocarbon stream, the method comprising obtaining a sensor data regarding a stream from a sulfur extraction process; determining a sulfur concentration data from the sensor data; and, comparing the sulfur concentration data to a first calibration data to determine a difference between the between the sulfur concentration data and the first calibration data. An embodiment of the invention is one, any or all of prior embodiments in this paragraph up through the first embodiment in this paragraph, wherein the first calibration data comprises data from an offline line analysis. An embodiment of the invention is one, any or all of prior embodiments in this paragraph up through the first embodiment in this paragraph, wherein, when a difference between the sulfur concentration data and the first calibration data is above a threshold, the method further comprising developing a second calibration data. An embodiment of the invention is one, any or all of prior embodiments in this paragraph up through the first embodiment in this paragraph, wherein the second calibration data comprises data from an offline line analysis. An embodiment of the invention is one, any or all of prior embodiments in this paragraph up through the first embodiment in this paragraph, further comprising comparing the sulfur concentration data to the second calibration data to determine a second difference between the between the sulfur concentration data and the second calibration data; and when the second difference is above a second threshold, calibrating the sensor based on the second calibration data. An embodiment of the invention is one, any or all of prior embodiments in this paragraph up through the first embodiment in this paragraph, wherein the determining a sulfur concentration data from the sensor data utilizes a temperature measurement. An embodiment of the invention is one, any or all of prior embodiments in this paragraph up through the first embodiment in this paragraph, wherein the sensor comprises an ORP sensor. An embodiment of the invention is one, any or all of prior embodiments in this paragraph up through the first embodiment in this paragraph, wherein the stream from a sulfur extraction process comprises a caustic stream. An embodiment of the invention is one, any or all of prior embodiments in this paragraph up through the first embodiment in this paragraph, wherein comparing the sulfur concentration data to a first calibration data to determine a difference between the between the sulfur concentration data and the first calibration data is performed at regular intervals.

A second embodiment of the invention is a method for calibrating a sensor used in a process for extracting sulfur compounds from a hydrocarbon stream, the method comprising obtaining a sensor data regarding a stream from a sulfur extraction process; determining a sulfur concentration data from the sensor data; comparing the sulfur concentration data to a first calibration data to determine a difference between the between the sulfur concentration data and the first calibration data; and, when a difference between the sulfur concentration data and the first calibration data is above a threshold, comparing the sulfur concentration data to a second calibration data different from the first calibration data to calibrate the sensor. An embodiment of the invention is one, any or all of prior embodiments in this paragraph up through the second embodiment in this paragraph, wherein the sensor comprises an ORP sensor. An embodiment of the invention is one, any or all of prior embodiments in this paragraph up through the second embodiment in this paragraph, wherein the stream from a sulfur extraction process comprises a caustic stream. An embodiment of the invention is one, any or all of prior embodiments in this paragraph up through the second embodiment in this paragraph, wherein the determining a sulfur concentration data from the sensor data utilizes a temperature measurement. An embodiment of the invention is one, any or all of prior embodiments in this paragraph up through the second embodiment in this paragraph, wherein the first calibration data comprises data from an offline line analysis, or wherein the second calibration data comprises data from an offline line analysis, or both. An embodiment of the invention is one, any or all of prior embodiments in this paragraph up through the second embodiment in this paragraph, wherein comparing the sulfur concentration data to a calibration data is performed at regular intervals.

A third embodiment of the invention is a process for removing sulfur compounds from a hydrocarbon stream, the process comprising extracting sulfur compounds with a caustic stream from a hydrocarbon feed stream to provide a treated hydrocarbon stream and a rich caustic stream; obtaining, with an ORP sensor, an ORP data regarding the rich caustic stream; oxidizing the sulfur compounds in the rich caustic stream in a presence of a catalyst to provide a lean caustic stream; determining a sulfur concentration data from the ORP data; comparing the sulfur concentration data to a first calibration data to determine a difference between the between the sulfur concentration data and the first calibration data; and, when a difference between the sulfur concentration data and the first calibration data is below a threshold, recommending at least one change to an operating condition associated with the process for removing sulfur compounds from the hydrocarbon stream. An embodiment of the invention is one, any or all of prior embodiments in this paragraph up through the third embodiment in this paragraph, wherein the determining a sulfur concentration data from the sensor data utilizes a temperature measurement. An embodiment of the invention is one, any or all of prior embodiments in this paragraph up through the third embodiment in this paragraph, when a difference between the sulfur concentration data and the first calibration data is above a threshold, comparing the sulfur concentration data to a second calibration data different from the first calibration data to calibrate the sensor. An embodiment of the invention is one, any or all of prior embodiments in this paragraph up through the third embodiment in this paragraph, further comprising developing the second calibration data. An embodiment of the invention is one, any or all of prior embodiments in this paragraph up through the third embodiment in this paragraph, wherein the second calibration data is developed in an offline test.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for validating a sensor used in a process for extracting sulfur compounds from a hydrocarbon stream, the method comprising:
obtaining a sensor data regarding a stream from a sulfur extraction process;
determining a sulfur concentration data from the sensor data; and,
comparing the sulfur concentration data to a first calibration data to determine a difference between the between the sulfur concentration data and the first calibration data.

2. The method of claim 1, wherein the first calibration data comprises data from an offline line analysis.

3. The method of claim 1, wherein, when a difference between the sulfur concentration data and the first calibration data is above a threshold, the method further comprising:
developing a second calibration data.

4. The method of claim 3, wherein the second calibration data comprises data from an offline line analysis.

5. The method of claim 3, further comprising:
comparing the sulfur concentration data to the second calibration data to determine a second difference between the between the sulfur concentration data and the second calibration data; and
when the second difference is above a second threshold, calibrating the sensor based on the second calibration data.

6. The method of claim 1, wherein the determining a sulfur concentration data from the sensor data utilizes a temperature measurement.

7. The method of claim 1, wherein the sensor comprises an ORP sensor.

8. The method of claim 1, wherein the stream from a sulfur extraction process comprises a caustic stream.

9. The method of claim 1, wherein comparing the sulfur concentration data to a first calibration data to determine a difference between the between the sulfur concentration data and the first calibration data is performed at regular intervals.

10. A method for calibrating a sensor used in a process for extracting sulfur compounds from a hydrocarbon stream, the method comprising:
obtaining a sensor data regarding a stream from a sulfur extraction process;
determining a sulfur concentration data from the sensor data;
comparing the sulfur concentration data to a first calibration data to determine a difference between the between the sulfur concentration data and the first calibration data; and,
when a difference between the sulfur concentration data and the first calibration data is above a threshold, comparing the sulfur concentration data to a second calibration data different from the first calibration data to calibrate the sensor.

11. The method of claim 10, wherein the sensor comprises an ORP sensor.

12. The method of claim 10, wherein the stream from a sulfur extraction process comprises a caustic stream.

13. The method of claim 10, wherein the determining a sulfur concentration data from the sensor data utilizes a temperature measurement.

14. The method of claim 10, wherein the first calibration data comprises data from an offline line analysis, or wherein the second calibration data comprises data from an offline line analysis, or both.

15. The method of claim 10, wherein comparing the sulfur concentration data to a calibration data is performed at regular intervals.

16. A process for removing sulfur compounds from a hydrocarbon stream, the process comprising:
extracting sulfur compounds with a caustic stream from a hydrocarbon feed stream to provide a treated hydrocarbon stream and a rich caustic stream;
obtaining, with an ORP sensor, an ORP data regarding the rich caustic stream;
oxidizing the sulfur compounds in the rich caustic stream in a presence of a catalyst to provide a lean caustic stream;
determining a sulfur concentration data from the ORP data;
comparing the sulfur concentration data to a first calibration data to determine a difference between the between the sulfur concentration data and the first calibration data; and,
when a difference between the sulfur concentration data and the first calibration data is below a threshold, recommending at least one change to an operating condition associated with the process for removing sulfur compounds from the hydrocarbon stream.

17. The process of claim 16, wherein the determining a sulfur concentration data from the sensor data utilizes a temperature measurement.

18. The process of claim 16, when a difference between the sulfur concentration data and the first calibration data is above a threshold, comparing the sulfur concentration data to a second calibration data different from the first calibration data to calibrate the sensor.

19. The process of claim 18, further comprising:
developing the second calibration data.

20. The process of claim 19, wherein the second calibration data is developed in an offline test.
